(19) United States
(12) Patent Application Publication
(10) Pub. No.: US 2015/0307388 A1
(43) Pub. Date: Oct. 29, 2015

(54) Glass for chemical tempering

(71) Applicant: Asahi Glass Company, Limited, Tokyo (JP)

(72) Inventors: Jun ENDO, Tokyo (JP); Shusaku Akiba, Tokyo (JP); Kazutaka Ono, Tokyo (JP); Shigeki Sawamura, Tokyo (JP)

(73) Assignee: Asahi Glass Company, Limited, Tokyo (JP)

(21) Appl. No.: 14/796,575

(22) Filed: Jul. 10, 2015

Related U.S. Application Data
(63) Continuation of application No. 13/451,798, filed on Apr. 20, 2012.

(30) Foreign Application Priority Data
May 23, 2011 (JP) 2011-114783
Nov. 11, 2011 (JP) 2011-247766

(51) Int. Cl. C03C 3/093; C03C 4/18; C03C 3/091; C03C 3/085; C03C 3/087

(52) U.S. Cl. CPC C03C 3/093; C03C 3/085; C03C 3/087; C03C 3/091; C03C 4/18; C03C 2204/00

(57) ABSTRACT

A glass for chemical tempering is provided. The glass contains as represented by mole percentage based on the following oxides, from 61 to 77% of SiO₂, from 11 to 18% of Al₂O₃, from 3 to 15% of MgO, from 0 to 0.5% of CaO, from 0 to 4% of ZrO₂, from 8 to 18% of Na₂O and from 0 to 1.9% of K₂O; wherein an R value calculated by the following formula by using contents of the respective components, is at least 0.66:

R=0.029×SiO₂+0.021×Al₂O₃+0.016×MgO−0.004×CaO+0.016×ZrO₂+0.029×Na₂O+0×K₂O−2.002

### TECHNICAL FIELD

The present invention relates to a method for producing chemically tempered glass which is suitable for e.g. a cover glass for a display device, such as a mobile device such as a cell phone or a personal digital assistance (PDA), a large-sized flat screen television such as a large-sized liquid crystal television or a large-sized plasma television, or a touch panel.

### BACKGROUND ART

In recent years, for a display device such as a mobile device, a liquid crystal television or a touch panel, a cover glass (protective glass) has been used in many cases in order to protect the display and to improve the appearance.

For such a display device, weight reduction and thickness reduction are required for differentiation by a flat design or for reduction of the load for transportation. Therefore, a cover glass to be used for protecting a display is also required to be thin. However, if the thickness of the cover glass is made to be thin, the strength is lowered, and there has been a problem such that the cover glass itself is broken by e.g. a shock due to falling or flying of an object in the case of a installed type or by dropping during the use in the case of a portable device, and the cover glass cannot accomplish the essential role to protect a display device.

In order to solve the above problem, it is conceivable to improve the strength of the cover glass, and as such a method, a method to form a compressive stress layer on a glass surface is commonly known.

The method to form a compressive stress layer on a glass surface, may typically be an air quenching tempering method (physical tempering method) wherein a surface of a glass plate heated to near the softening point is quenched by air cooling or the like, or a chemical tempering method wherein alkali metal ions having a small ion radius (typically Li ions or Na ions) at a glass plate surface are exchanged with alkali ions having a larger ion radius (typically K ions) by ion exchange at a temperature lower than the glass transition point.

As mentioned above, the thickness of the cover glass is required to be thin. However, if the air quenching tempering method is applied to a thin glass plate having a thickness of less than 1 mm, as required for a cover glass, the temperature difference between the surface and the inside tends not to arise, and it is thereby difficult to form a compressive stress layer, and the desired property of high strength cannot be obtained. Therefore, a cover glass tempered by the latter chemical tempering method is usually used.

As such a cover glass, one having soda lime glass chemically tempered is widely used (e.g. Patent Document 1).

Soda lime glass is inexpensive and has a feature that the surface compressive stress S of a compressive stress layer formed at the surface of the glass by the chemical tempering can be made to be at least 200 MPa, but there has been a problem that it is difficult to make the thickness t of the compressive stress layer to be at least 30 μm.

Therefore, one having SiO₂—Al₂O₃—Na₂O type glass different from soda lime glass, chemically tempered, has been proposed for such a cover glass (e.g. Patent Document 2).

Such SiO₂—Al₂O₃—Na₂O type glass has a feature that it is possible not only to make the above S to be at least 200 MPa but also to make the above t to be at least 30 μm.

### PRIOR ART DOCUMENTS

### Patent Documents

Patent Document 1: JP-A-2007-11210

Patent Document 2: U.S. Patent Application Publication No. 2008/0286548

### DISCLOSURE OF INVENTION

### Technical Problem

In the above-described application, etc., ion exchange treatment for chemical tempering is usually carried out by immersing glass containing sodium (Na) in a molten potassium salt, and as such a potassium salt, potassium nitrate or a mixed salt of potassium nitrate and sodium nitrate, is used.

In such ion exchange treatment, ion exchange of Na in the glass with potassium (K) in the molten salt is carried out. Therefore, if the ion exchange treatment is repeated by using the same molten salt, the Na concentration in the molten salt increases.

If the Na concentration in the molten salt increases, the surface compressive stress S of the chemically tempered glass decreases, and therefore, there has been a problem that it is necessary to strictly watch the Na concentration in the molten salt and to frequently carry out replacement of the molten salt, so that S of the chemically tempered glass will not become lower than the desired value.

It is desired to reduce the frequency of such replacement of the molten salt, and it is an object of the present invention to provide a method for producing chemically tempered glass, whereby such a problem can be solved.

### Solution to Problem

The present invention provides a method for producing chemically tempered glass, which comprises repeating ion exchange treatment of immersing glass in a molten salt to obtain chemically tempered glass, wherein the glass comprises, as represented by mole percentage based on the following oxides, from 61 to 77% of SiO₂, from 1 to 18% of Al₂O₃, from 3 to 15% of MgO, from 0 to 5% of CaO, from 0 to 4% of ZrO₂, from 8 to 18% of Na₂O and from 0 to 6% of K₂O; the total content of SiO₂ and Al₂O₃ is from 65 to 85%; the total content of MgO and CaO is from 3 to 15%; and R calculated by the following formula by using contents of the respective components, is at least 0.66 (hereinafter sometimes referred to as the first invention). Further, the glass to be used here may be referred to as the first glass of the present invention, and, for example, SiO₂ in the following formula is the content of SiO₂ as represented by mole percentage.

R=0.029×SiO₂+0.021×Al₂O₃+0.016×MgO−0.004×CaO+0.016×ZrO₂+0.029×Na₂O+0×K₂O−2.002

The total content of SiO₂, Al₂O₃, MgO, CaO, ZrO₂, Na₂O and K₂O in the first glass of the present invention is typically at least 98.5%.

Further, the present invention provides a method for producing chemically tempered glass, which comprises repeating ion exchange treatment of immersing glass in a molten salt to obtain chemically tempered glass, wherein the glass comprises, as represented by mole percentage based on the following oxides, from 61 to 77% of SiO₂, from 1 to 18% of Al₂O₃, from 3 to 15% of MgO, from 0 to 5% of CaO, from 0 to 4% of ZrO₂, from 8 to 18% of Na₂O, from 0 to 6% of K₂O and at least one component selected from B₂O₃, SrO and BaO; the total content of SiO₂ and Al₂O₃ is from 65 to 85%; the total content of MgO and CaO is from 3 to 15%; and R′ calculated by the following formula by using contents of the respective components, is at least 0.66 (hereinafter sometimes referred to as the second invention). Further, the glass to be used here may be referred to as the second glass of the present invention.

R′=0.029×SiO₂+0.021×Al₂O₃+0.016×MgO−0.004×CaO+0.016×ZrO₂+0.029×Na₂O+0×K₂O+0.028×B₂O₃+0.012×SrO+0.026×BaO−2.002

The total content of SiO₂, Al₂O₃, MgO, CaO, ZrO₂, Na₂O, K₂O, B₂O₃, SrO and BaO in the second glass of the present invention is typically at least 98.5%.

Further, the present invention provides a method for producing chemically tempered glass, which comprises repeating ion exchange treatment of immersing glass in a molten salt to obtain chemically tempered glass, wherein the glass comprises, as represented by mole percentage based on the following oxides, from 61 to 77% of SiO₂, from 1 to 18% of Al₂O₃, from 3 to 15% of MgO, from 0 to 5% of CaO, from 0 to 4% of ZrO₂, from 8 to 18% of Na₂O, from 0 to 6% of K₂O and at least one component selected from B₂O₃, SrO, BaO, ZnO, Li₂O and SnO₂; the total content of SiO₂ and Al₂O₃ is from 65 to 85%; the total content of MgO and CaO is from 3 to 15%; and R″ calculated by the following formula by using contents of the respective components, is at least 0.66 (hereinafter sometimes referred to as the third invention). Further, the glass to be used here may be referred to as the third glass of the present invention.

R″=0.029×SiO₂+0.021×Al₂O₃+0.016×MgO−0.004×CaO+0.016×ZrO₂+0.029×Na₂O+0×K₂O+0.028×B₂O₃+0.012×SrO+0.026×BaO+0.019×ZnO+0.033×Li₂O+0.032×SnO₂−2.002

Total content of SiO₂, Al₂O₃, MgO, CaO, ZrO₂, Na₂O, K₂O, B₂O₃, SrO, BaO, ZnO, Li₂O and SnO₂ in the third glass of the present invention is typically at least 98.5%.

Further, the present invention provides a method for producing chemically tempered glass, which comprises repeating ion exchange treatment of immersing glass in a molten salt to obtain chemically tempered glass, wherein the glass comprises, as represented by mole percentage based on the following oxides, from 62 to 77% of SiO₂, from 1 to 18% of Al₂O₃, from 3 to 15% of MgO, from 0 to 5% of CaO, from 0 to 4% of ZrO₂ and from 8 to 18% of Na₂O; the total content of SiO₂ and Al₂O₃ is from 65 to 85%; the total content of MgO and CaO is from 3 to 15%; and the glass contains no K₂O (hereinafter sometimes referred to as the fourth invention). The first, second, third and fourth glasses of the present invention will be generally referred to as the glass of the present invention.

Further, the present invention provides the method for producing chemically tempered glass, wherein SiO₂ is at least 61%, Al₂O₃ is from 3 to 12%, MgO is at most 12% and CaO is from 0 to 3%.

Further, the present invention provides the method for producing chemically tempered glass, wherein ZrO₂ is at most 2.5% and Na₂O is at least 10%.

Further, the present invention provides the method for producing chemically tempered glass, wherein Al₂O₃ is at least 9% and CaO is from 0 to 2%.

Further, the present invention provides the method for producing chemically tempered glass, wherein the total content of SiO₂, Al₂O₃, MgO, CaO, ZrO₂, Na₂O and K₂O, is at least 98.5%.

Further, the present invention provides the method for producing chemically tempered glass, wherein a compressive stress layer formed at the surface of the chemically tempered glass has a thickness of at least 10 μm and a surface compressive stress of at least 200 MPa.

Further, the present invention provides the method for producing chemically tempered glass, wherein the chemically tempered glass is a glass plate having a thickness of at most 1.5 mm.

Further, the present invention provides the method for producing chemically tempered glass, wherein the chemically tempered glass is a cover glass.

The present inventors have considered that there may be a relation between the composition of Na-containing glass and such a phenomenon that by repeating ion exchange treatment of immersing the Na-containing glass in a molten potassium salt many times to obtain chemically tempered glass, the Na concentration in the molten potassium salt increases and at the same time, the surface compressive stress of the chemically tempered glass becomes small, and have conducted the following experiment.

Firstly, 29 types of glass plates were prepared which had compositions as represented by mol % in Tables 1 to 3 and each of which had a thickness of 1.5 mm and a size of 20 mm×20 mm and had both sides mirror-polished with cerium oxide.

The glass transition points Tg (unit: ° C.) and Young's modulus E (unit: GPa) of these glasses are also shown in the same Tables.

Here, those provided with * are ones calculated from the compositions.

Tg was measured as follows. That is, by means of a differential thermal dilatometer, the elongation percentage of glass was measured to a yield point when the temperature was raised from room temperature at a rate of 5° C./min using quartz glass as a reference sample, and the temperature corresponding to a folding point in the obtained thermal expansion curve was taken as the glass transition point.

E was measured by an ultrasonic pulse method with respect to a glass plate having a thickness of from 5 to 10 mm and a size of 3 cm×3 cm.

These 29 types of glass plates were subjected to ion exchange of immersing for 10 hours in a molten potassium salt having a KNO₃ content of 100% and having a temperature of 400° C. to obtain chemically tempered glass plates, whereupon their surface compressive stresses CS1 (unit: MPa) were measured. Here, glass A27 is glass used for a cover glass for a mobile device.

Further, these 29 types of glass plates were subjected to ion exchange of immersing for 10 hours in a molten potassium salt having a KNO₃ content of 95% and a NaNO₃ content of 5% and having a temperature of 400° C. to obtain chemically tempered glass plates, and their surface compressive stresses CS2 (unit: MPa) were measured. Here, CS1 and CS2 were measured by means of a surface stress meter FSM-6000, manufactured by Orihara Manufacturing Co., Ltd.

CS1 and CS2 are shown together with their ratio r=CS2/CS1 in the corresponding rows in Tables 1 to 3.

TABLE 1

| Glass | 1 | 2 | A1 | A2 | A3 | A4 | A5 | A6 | A7 | A8 |
|---|---|---|---|---|---|---|---|---|---|---|
| SiO₂ | 73.0 | 72.0 | 64.3 | 64.3 | 64.3 | 64.3 | 63.8 | 63.8 | 64.3 | 64.3 |
| Al₂O₃ | 7.0 | 6.0 | 6.5 | 7.0 | 6.5 | 7.0 | 7.0 | 7.5 | 6.0 | 6.0 |
| MgO | 6.0 | 10.0 | 11.0 | 11.0 | 11.0 | 11.0 | 11.0 | 11.0 | 11.5 | 12.0 |
| CaO | 0 | 0 | 0.1 | 0.1 | 0.1 | 0.1 | 0.1 | 0.1 | 0.1 | 0.1 |
| SrO | 0 | 0 | 0.1 | 0.1 | 0.1 | 0.1 | 0.1 | 0.1 | 0.1 | 0.1 |
| BaO | 0 | 0 | 0.1 | 0.1 | 0.1 | 0.1 | 0.1 | 0.1 | 0.1 | 0.1 |
| ZrO₂ | 0 | 0 | 2.0 | 1.5 | 1.5 | 1.0 | 1.5 | 1.0 | 2.0 | 1.5 |
| Na₂O | 14.0 | 12.0 | 12.0 | 12.0 | 12.5 | 12.5 | 12.5 | 12.5 | 12.0 | 12.0 |
| K₂O | 0 | 0 | 4.0 | 4.0 | 4.0 | 4.0 | 4.0 | 4.0 | 4.0 | 4.0 |
| Tg | 617 | 647 | 615 | 617 | 608 | 603 | 614 | 610 | 615 | 609 |
| E | 70.8 | 73.1 | 75.8 | 75.3 | 74.9 | 74.4 | 75.1 | 74.8 | 75.8 | 75.3 |
| CS1 | 888 | 900 | 1049 | 1063 | 1035 | 1047 | 1063 | 1046 | 1020 | 1017 |
| CS2 | 701 | 671 | 589 | 593 | 601 | 590 | 601 | 599 | 588 | 579 |
| r | 0.79 | 0.75 | 0.56 | 0.56 | 0.58 | 0.56 | 0.57 | 0.57 | 0.58 | 0.57 |
| R | 0.76 | 0.72 | 0.55 | 0.56 | 0.56 | 0.56 | 0.56 | 0.56 | 0.55 | 0.55 |
| R′ | 0.76 | 0.72 | 0.56 | 0.56 | 0.57 | 0.57 | 0.56 | 0.56 | 0.56 | 0.56 |
| R″ | 0.76 | 0.72 | 0.56 | 0.56 | 0.57 | 0.57 | 0.56 | 0.56 | 0.56 | 0.56 |

TABLE 2

| Glass | A9 | A10 | A11 | A12 | A13 | A14 | A15 | A16 | A17 | A18 |
|---|---|---|---|---|---|---|---|---|---|---|
| SiO₂ | 64.3 | 64.3 | 64.3 | 64.3 | 64.3 | 65.3 | 64.3 | 60.3 | 56.3 | 64.3 |
| Al₂O₃ | 7.2 | 7.0 | 6.0 | 6.0 | 8.0 | 7.0 | 10.0 | 11.5 | 15.5 | 8.0 |
| MgO | 11.0 | 11.0 | 12.5 | 13.0 | 11.0 | 11.0 | 8.5 | 11.0 | 11.0 | 10.5 |
| CaO | 0.1 | 0.1 | 0.1 | 0.1 | 0.1 | 0.1 | 0.1 | 0.1 | 0.1 | 0.1 |
| SrO | 0.1 | 0.1 | 0.1 | 0.1 | 0.1 | 0.1 | 0.1 | 0.1 | 0.1 | 0.1 |
| BaO | 0.1 | 0.1 | 0.1 | 0.1 | 0.1 | 0.1 | 0.1 | 0.1 | 0.1 | 0.1 |
| ZrO₂ | 0.5 | 1.5 | 1.0 | 0.5 | 0.5 | 0.5 | 0 | 0 | 0 | 0.5 |
| Na₂O | 12.7 | 11.5 | 12.0 | 12.0 | 12.0 | 12.0 | 13.0 | 13.0 | 13.0 | 12.5 |
| K₂O | 4.0 | 4.5 | 4.0 | 4.0 | 4.0 | 4.0 | 4.0 | 4.0 | 4.0 | 4.0 |
| Tg | 597 | 599* | 586* | 582* | 614 | 591* | 602* | 608* | 633* | 608 |
| E | 73.6 | 75.6 | 75.2 | 74.6 | 74.8 | 74.1 | 72* | 74* | 75* | 74.4 |
| CS1 | 1003 | 1013 | 984 | 963 | 954 | 983 | 1072 | 1145 | 1221 | 1024 |
| CS2 | 588 | 564 | 561 | 546 | 576 | 574 | 640 | 641 | 647 | 582 |
| r | 0.59 | 0.56 | 0.57 | 0.57 | 0.60 | 0.58 | 0.60 | 0.56 | 0.53 | 0.57 |
| R | 0.57 | 0.54 | 0.55 | 0.55 | 0.56 | 0.57 | 0.59 | 0.54 | 0.51 | 0.57 |
| R′ | 0.57 | 0.55 | 0.56 | 0.56 | 0.57 | 0.57 | 0.59 | 0.54 | 0.51 | 0.57 |
| R″ | 0.57 | 0.55 | 0.56 | 0.56 | 0.57 | 0.57 | 0.59 | 0.54 | 0.51 | 0.57 |

TABLE 3

| Glass | A19 | A20 | A21 | A22 | A23 | A24 | A25 | A26 | A27 |
|---|---|---|---|---|---|---|---|---|---|
| SiO₂ | 64.3 | 63.5 | 66.0 | 64.5 | 65.0 | 63.5 | 64.3 | 71.3 | 66.7 |
| Al₂O₃ | 8.5 | 10.5 | 9.0 | 9.0 | 5.0 | 5.0 | 6.0 | 2.0 | 10.8 |
| MgO | 10.5 | 9.0 | 8.0 | 12.0 | 12.0 | 8.0 | 11.0 | 10.4 | 6.2 |
| CaO | 0.1 | 0 | 0 | 0 | 0.5 | 4.0 | 0.1 | 0.3 | 0.6 |
| SrO | 0.1 | 0 | 0 | 0 | 0 | 0 | 0.1 | 0.03 | 0 |
| BaO | 0.1 | 0 | 0 | 0 | 0 | 0 | 0.1 | 0.02 | 0 |
| ZrO₂ | 0 | 0 | 0 | 0 | 0 | 1.3 | 2.5 | 0.5 | 0 |
| Na₂O | 12.5 | 15.0 | 15.0 | 11.5 | 11.0 | 9.4 | 12.0 | 10.8 | 13.2 |
| K₂O | 4.0 | 2.0 | 2.0 | 3.0 | 6.5 | 8.9 | 4.0 | 4.6 | 2.4 |
| Tg | 594* | 598* | 599 | 648 | 568* | 580* | 620 | 566* | 595 |
| E | 73* | 74* | 72* | 75* | 71* | 70* | 78 | 71* | 72* |
| CS1 | 985 | 1190 | 1054 | 919 | 746 | 668 | 1019 | 664 | 1039 |
| CS2 | 577 | 752 | 722 | 516 | 382 | 240 | 571 | 407 | 679 |
| r | 0.59 | 0.63 | 0.69 | 0.56 | 0.51 | 0.36 | 0.56 | 0.61 | 0.65 |
| R | 0.57 | 0.64 | 0.66 | 0.58 | 0.50 | 0.35 | 0.55 | 0.59 | 0.64 |
| R′ | 0.58 | 0.64 | 0.66 | 0.58 | 0.50 | 0.35 | 0.56 | 0.59 | 0.64 |
| R″ | 0.58 | 0.64 | 0.66 | 0.58 | 0.50 | 0.35 | 0.56 | 0.59 | 0.64 |

From these results, it has been found that there is a high correlation between R calculated by above formula (shown in Tables 1 to 3) and the above r. FIG. 1 is a scatter graph to make this point clear wherein the abscissa represents R and the ordinate represents r, and the straight line in the Fig. represents r=1.033×R−0.0043, and the correlation coefficient is 0.97.

Further, values of the above R′ and R″ are also shown below the row for R in Tables 1 to 3.

From the above correlation found by the present inventors, the following is evident. That is, in order to reduce the frequency of replacement of the molten salt, glass having a less degree of decrease in the surface compressive stress S due to an increase of the Na concentration i.e. glass having the above r being large, may be used, and for such a purpose, the above R of the glass may be made to be large.

Further, r of conventional glass A27 is 0.65, and when R is made to be at least 0.66, r becomes roughly at least 0.68 i.e. is distinctly larger than glass A27, whereby it becomes possible to remarkably reduce the frequency of replacement of the molten salt, or to substantially relax the watching of the molten salt.

The strength of the chemically tempered glass depends largely on the surface compressive stress, and the smaller the surface compressive stress, the lower the strength of the chemically tempered glass. Therefore, the surface compressive stress obtainable by the chemical tempering treatment is required to be at least 68% as compared with the surface compressive stress when the Na concentration in the molten salt is 0%, i.e. r is required to be at least 0.68. From this viewpoint, when the Na concentration in the molten salt is represented by C, the useful range of C is the range which satisfies the following formula.

0.68≦(r−1)×C/5+1

Thus, C≦1.6/(1−r) must be satisfied.

If r is less than 0.68, the decrease ratio of the surface compressive stress of the chemically tempered glass due to an increase of the Na concentration in the molten salt is large, whereby such a molten salt is useful only within a narrow range where the Na concentration is less than 5.0%, and the frequency of replacement increases. When r is 0.75, 0.79 and 0.81, the molten salt becomes useful within a wide range of the Na concentration where the Na concentration is at most 6.4%, at most 7.6% and at most 8.4%, respectively, and thus, when r is 0.75, 0.79 and 0.81, the frequency of replacement can be suppressed to be 78%, 66% and 59%, respectively, as compared with the case where r is 0.68. Accordingly, r is preferably at least 0.70, more preferably at least 0.75, further preferably at least 0.79, particularly preferably at least 0.81.

On the other hand, if r is less than 0.68, the change in the surface compressive stress S of the chemically tempered glass due to a change of the Na concentration in the molten salt is large, whereby adjustment of the surface compressive stress tends to be difficult, and watching of the Na concentration in the molten salt is required to be strict.

Further, when glasses 1 and 2 having r being largest among 29 types of glasses, are compared with other 27 types of glasses, they are common in that they contain no K₂O. On the other hand, the coefficient relating to K₂O in the above formula for calculation of R is 0 and is substantially small as compared with the coefficient of 0.029 relating to Na₂O being the same alkali metal oxide, and this explains such a point.

The present invention has been accomplished on the basis of the above finding.

### Advantageous Effects of Invention

According to the present invention, the decrease ratio of the surface compressive stress S of chemically tempered glass due to an increase of the Na concentration in the molten salt can be made small, whereby it is possible to relax the watching of the Na concentration in the molten salt and to reduce the frequency of replacement of the molten salt.

Further, the decrease ratio of S of chemically tempered glass immediately before replacement of the molten salt to S of chemically tempered glass obtained by the first ion exchange treatment becomes small, whereby variation in S among lots can be made small.

### BRIEF DESCRIPTION OF DRAWINGS

FIG. 1 is a graph showing the relation between R obtained by calculation from the glass composition and the decrease ratio r of the surface compressive stress due to an increase of the Na concentration in the molten potassium salt.

FIG. 2 is a graph showing the relation between R′ obtained by calculation from the glass composition and the decrease ratio r of the surface compressive stress due to an increase of the Na concentration in the molten potassium salt. The straight line in the Fig. represents r=1.048×R′−0.0135, and the correlation coefficient is 0.98. The glasses used for the preparation of this graph are 67 types of glasses in total i.e. 29 types of glasses in Tables 1 to 3, 20 types of glasses in Tables 4 and 5 given hereinafter, 7 types of glasses 23 to 29 in Table 6 given hereinafter, 5 types of glasses 36 to 40 in Table 7 given hereinafter, and 6 types of glasses 41 to 46 in Table 8 given hereinafter.

FIG. 3 is a graph showing the relation between R″ obtained by calculation from the glass composition and the decrease ratio r of the surface compressive stress due to an increase of the Na concentration in the molten potassium salt. The straight line in the Fig. represents r=1.014×R″+0.0074, and the correlation coefficient is 0.95. The glasses used for the preparation of this graph are 94 types of glasses in total i.e. 29 types of glasses in Tables 1 to 3, 20 types of glasses in Tables 4 and 5 given hereinafter, 7 types of glasses 23 to 29 in Table 6 given hereinafter, 5 types of glasses 36 to 40 in Table 7 given hereinafter, 6 types of glasses 41 to 46 in Table 8 given hereinafter, 8 types of glasses 49, 51 to 55, 57 and 58 in Table 9 given hereinafter, 8 types of glasses 59 to 64, 66 and 68 in Table 10 given hereinafter, 5 types of glasses 69, 73, 74, 77 and 78 in Table 11 given hereinafter, and 6 types of glasses 79 to 82, 84 and 85 in Table 12 given hereinafter.

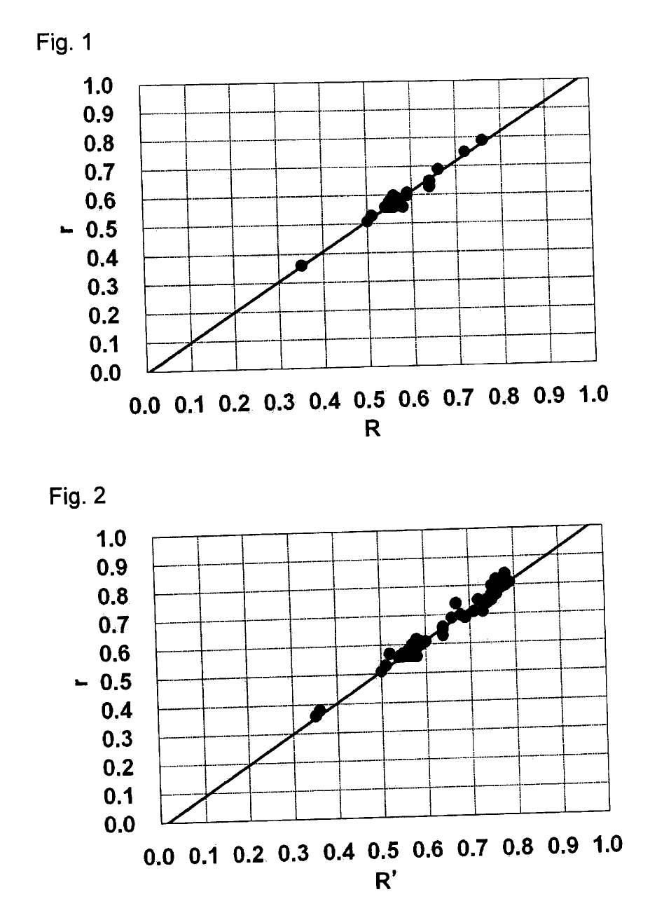

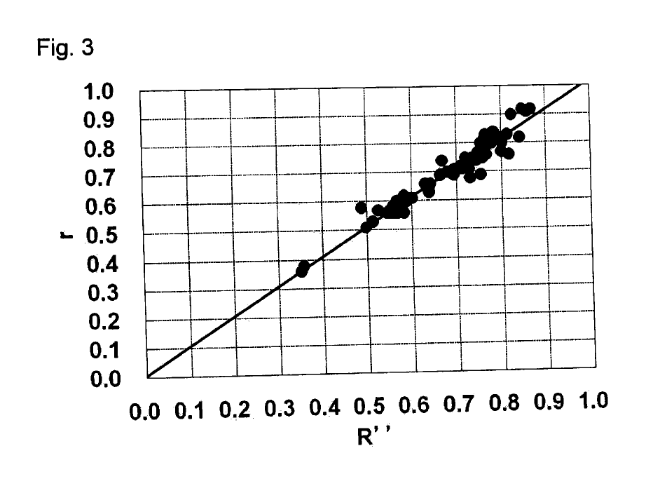

### DESCRIPTION OF EMBODIMENTS

The surface compressive stress S of chemically tempered glass to be produced by the method of the present invention (hereinafter sometimes referred to as chemically tempered glass of the present invention) is typically at least 200 MPa, but in the case of a cover glass, etc., S is preferably at least 400 MPa, more preferably at least 550 MPa, particularly preferably more than 700 MPa. Further, S is typically at most 1,200 MPa.

The thickness t of the compressive stress layer of chemically tempered glass of the present invention is typically at least 10 μm, preferably at least 30 μm, more preferably more than 40 μm. Further, t is typically at most 70 μm.

In the present invention, the molten salt is not particularly limited so long as Na in the glass surface layer cab be ion exchanged with K in the molten salt, and it may, for example, be molten potassium nitrate (KNO₃).

In order to make it possible to carry out the above ion exchange, the molten salt is required to be a molten salt containing K, but there is no other restriction so long as the object of the present invention is not impaired. As the molten salt, the above-mentioned molten KNO₃ is usually used, but one containing, in addition to KNO₃, at most about 5% of NaNO₃, is also commonly used. Further, in the molten salt containing K, the proportion of K ions in cations is typically at least 0.7 by molar ratio.

Ion exchange treatment conditions to form a chemically tempered layer (compressive stress layer) having a desired surface compressive stress may vary depending upon e.g. the thickness in the case of a glass plate. However, it is typical to immerse a glass substrate in molten KNO₃ at from 350 to 550° C. for from 2 to 20 hours. From the economical viewpoint, the immersion is carried out under conditions of from 350 to 500° C. and from 2 to 16 hours, and more preferably, the immersion time is from 2 to 10 hours.

In the method of the present invention, ion exchange treatment is repeated typically in such a manner that glass is immersed in the molten salt to carry out ion exchange treatment to form chemically tempered glass, then the chemically tempered glass is taken out from the molten salt and then, another glass is immersed in the molten salt to form chemically tempered glass, and then such chemically tempered glass is taken out from the molten salt.

The thickness of glass is from 0.4 to 1.2 mm, and the thickness t of a compressive stress layer of one having a glass plate made of glass of the present invention chemically tempered, is at least 30 μm, and the surface compressive stress S is preferably at least 550 MPa. Typically, t is from 40 to 60 μm, and S is from 650 to 820 MPa.

A glass plate for a display device of the present invention is usually obtained by chemically tempering a glass plate obtained by processing a glass plate made of glass of the present invention by e.g. cutting, hole making, polishing, etc.

The thickness of the glass plate for a display device of the present invention is typically from 0.3 to 2 mm, usually from 0.4 to 1.2 mm.

The glass plate for a display device of the present invention is typically a cover glass.

A method for producing a glass plate made of glass of the present invention is not particularly limited, and for example, various raw materials are mixed in proper amounts, heated and melted at from about 1,400 to 1,700° C. and then homogenized by defoaming, stirring or the like and formed into a plate by a well known float process, downdraw method or press method, which is annealed and then cut into a desired size to obtain the glass plate.

The glass transition point Tg of the glass of the present invention is preferably at least 400° C. If it is lower than 400° C., the surface compressive stress is likely to be relaxed during the ion exchange, and no adequate stress may be obtained. Tg is typically at least 570° C.

The Young's modulus E of the glass of the present invention is preferably at least 66 MPa. If it is less than 66 MPa, the fracture toughness tends to be low, and the glass tends to be easily broken. In a case where it is used for the production of a glass plate for a display device of the present invention, E of the glass of the present invention is preferably at least 67 MPa, more preferably at least 68 MPa, further preferably at least 69 MPa, particularly preferably at least 70 MPa.

Now, the composition of the glass of the present invention will be described by using contents represented by mole percentage unless otherwise specified.

SiO₂ is a component to constitute a glass matrix and is essential. If it is less than 61%, the change in the surface compressive stress due to the NaNO₃ concentration in the KNO₃ molten salt tends to be large, and cracking is likely to be formed when the glass surface is damaged, the weather resistance tends to deteriorate, the specific gravity tends to increase, or the liquid phase temperature tends to increase whereby the glass tends to be instable. It is preferably at least 62%, typically at least 63%. Further, in the fourth glass of the present invention, SiO₂ is at least 62%.

If SiO₂ exceeds 77%, the temperature T2 at which the viscosity becomes 10² dPa·s and the temperature T4 at which the viscosity becomes 10⁴ dPa·s will increase, whereby melting or molding of glass tends to be difficult, or the weather resistance tends to deteriorate. It is preferably at most 76%, more preferably at most 75%, further preferably at most 74%, particularly preferably at most 73%.

Al₂O₃ is a component to improve the ion exchange performance and weather resistance, and is essential. If it is less than 1%, it tends to be difficult to obtain the desired surface compressive stress S or compressive stress layer thickness t by ion exchange, or the weather resistance tends to deteriorate. It is preferably at least 3%, more preferably at least 4%, further preferably at least 5%, particularly preferably at least 6%, typically at least 7%. If it exceeds 18%, the change in the surface compressive stress due to the NaNO₃ concentration in the KNO₃ molten salt tends to be large, T2 or T4 tends to increase, whereby melting or molding of glass tends to be difficult, or the liquid phase temperature tends to be high, whereby devitrification is likely to occur. It is preferably at most 12%, more preferably at most 11%, further preferably at most 10%, particularly preferably at most 9%, typically at most 8%.

In a case where it is particularly desired to minimize the change in the surface compressive stress due to the NaNO₃ concentration in the KNO₃ molten salt, Al₂O₃ is preferably less than 6%.

The total content of SiO₂ and Al₂O₃ is typically from 66 to 83%.

MgO is a component to improve the melting property, and is essential. If it is less than 3%, the melting property or Young's modulus tends to deteriorate. It is preferably at least 4%, more preferably at least 5%, further preferably at least 6%. In a case where it is particularly desired to increase the melting property, MgO is preferably more than 7%.

If MgO exceeds 15%, the change in the surface compressive stress due to the NaNO₃ concentration in the KNO₃ molten salt tends to be large, the liquid phase temperature tends to increase, whereby devitrification is likely to occur, or the ion exchange rate tends to deteriorate. It is preferably at most 12%, more preferably at most 11%, further preferably at most 10%, particularly preferably at most 8%, typically at most 7%.

CaO may be contained up to 5% in order to improve the melting property at a high temperature or to prevent devitrification, but it is likely to increase the change in the surface compressive stress due to the NaNO₃ concentration in the KNO₃ molten salt, or to lower the ion exchange rate or the durability against cracking. In a case where CaO is contained, its content is preferably at most 3%, more preferably at most 2%, further preferably at most 1.5%, particularly preferably at most 1%, most preferably at most 0.5%, and typically, no CaO is contained.

In a case where CaO is contained, the total content of MgO and CaO is preferably at most 15%. If it exceeds 15%, the change in the surface compressive stress due to the NaNO₃ concentration in the KNO₃ molten salt tends to be large, or the ion exchange rate or the durability against cracking is likely to deteriorate. It is preferably at most 14%, more preferably at most 13%, further preferably at most 12%, particularly preferably at most 11%.

Na₂O is a component to reduce the change in the surface compressive stress due to a NaNO₃ concentration in the KNO₃ molten salt, to form a surface compressive stress layer by ion exchange, or to improve the melting property of glass, and is essential. If it is less than 8%, it becomes difficult to form a desired surface compressive stress layer by ion exchange, or it becomes difficult to melt or mold the glass as T2 or T4 increases. It is preferably at least 9%, more preferably at least 10%, further preferably at least 11%, particularly preferably at least 12%. If Na₂O exceeds 18%, the weather resistance tends to deteriorate, or cracking is likely to form from an indentation. It is preferably at most 17%, more preferably at most 16%, further preferably at most 15%, particularly preferably at most 14%.

K₂O is not essential but is a component to increase the ion exchange rate, and thus, it may be contained up to 6%. If it exceeds 6%, the change in the surface compressive stress due to a NaNO₃ concentration in the KNO₃ molten salt becomes large, cracking is likely to be formed from an indentation, or the weather resistance tends to deteriorate. It is preferably at most 4%, more preferably at most 3%, further preferably at most 1.9%, particularly preferably at most 1%, and typically no K₂O is contained. Here, the fourth glass of the present invention contains no K₂O.

In a case where K₂O is contained, the total content R₂O of Na₂O and K₂O is preferably from 8.5 to 20%. If the total content exceeds 20%, the weather resistance tends to deteriorate, or cracking is likely to be formed from an indentation. The total content is preferably at most 19%, more preferably at most 18%, further preferably at most 17%, particularly preferably at most 16%. On the other hand, if R₂O is less than 8.5%, the melting property of glass tends to deteriorate. It is preferably at least 9%, more preferably at least 10%, further preferably at least 11%, particularly preferably at least 12%.

ZrO₂ is not an essential component, but may be contained up to 4%, for example, to increase the surface compressive stress or to improve the weather resistance. If it exceeds 4%, the change in the surface compressive stress due to a NaNO₃ concentration in the KNO₃ molten salt becomes large, or the resistance against cracking tends to deteriorate. It is preferably at most 2.5%, more preferably at most 2%, further preferably at most 1%, particularly preferably at most 0.5%, and typically no ZrO₂ is contained.

The glass of the present invention essentially comprises the above-described components, but may contain other components within a range not to impair the object of the present invention. In a case where such other components are contained, the total content of such components is preferably at most 5%, more preferably at most 3%, particularly preferably at most 2%, typically less than 1.5%. Now, such other components will be exemplified.

SrO may be contained in order to improve the melting property at a high temperature or to prevent devitrification, but it is likely to increase the change in the surface compressive stress due to a NaNO₃ concentration in the KNO₃ molten salt, or to decrease the ion exchange rate or the durability against cracking. The content of SrO is preferably at most 1%, more preferably at most 0.5%, and typically no SrO is contained.

BaO may be contained in order to improve the melting property at a high temperature or to prevent devitrification, but it may increase the change in the surface compressive stress due to a NaNO₃ concentration in the KNO₃ molten salt, or to decrease the ion exchange rate or the durability against cracking. The content of BaO is preferably at most 1%, more preferably at most 0.5%, and typically no BaO is contained.

The total content RO of MgO, CaO, SrO and BaO is preferably at most 15%. If the total content exceeds 15%, the change in the surface compressive stress due to a NaNO₃ concentration in the KNO₃ molten salt becomes large, or the ion exchange rate or the durability against cracking tends to deteriorate. The total content is preferably at most 14%, more preferably at most 13%, further preferably at most 12%, particularly preferably at most 11%.

ZnO may be contained in order to improve the melting property of glass at a high temperature, but in such a case, the content is preferably at most 1%. In the production by a float process, it is preferably controlled to be at most 0.5%. If it exceeds 0.5%, it is likely to be reduced during the float forming to form a product defect. Typically no ZnO is contained.

B₂O₃ is preferably at most 5% in order to improve the melting property. If it exceeds 5%, homogeneous glass tends to be hardly obtainable, and molding of glass is likely to be difficult. It is preferably at most 4%, more preferably at most 3%, further preferably at most 1.7%, further preferably at most 1%, particularly preferably at most 0.5%, and typically no B₂O₃ is contained.

In a case where SrO, BaO or B₂O₃ is contained, the above-mentioned R′ is preferably at least 0.66.

Further, the second glass of the present invention contains at least one component selected from B₂O₃, SrO and BaO.

TiO₂ is likely to deteriorate the visible light transmittance and to color glass to be brown when it is coexistent with Fe ions in the glass, and therefore, it is preferably at most 1%, if contained, and typically, it is not contained.

Li₂O is a component to lower the strain point and to bring about a stress relaxation thereby to make it difficult to stably obtain a surface compressive stress layer and therefore is preferably at most 4.3%, more preferably at most 3%, further preferably at most 2%, particularly preferably at most 1%, and typically, no Li₂O is contained.

SnO₂ may be contained, for example, in order to improve the weather resistance, but even in such a case, the content is preferably at most 3%, more preferably at most 2%, further preferably at most 1%, particularly preferably at most 0.5%, and typically no SnO₂ is contained.

Further, the third glass of the present invention contains at least one component selected from B₂O₃, SrO, BaO, ZnO, Li₂O and SnO₂.

As a clarifying agent at the time of melting glass, SO₃, a chloride or a fluoride may suitably be contained. However, in order to increase the visibility of display devices such as touch panels, it is preferred to reduce contamination by impurities such as Fe₂O₃, NiO or Cr₂O₃ having an absorption in a visible light range in raw materials as far as possible, and the content of each of them is preferably at most 0.15%, more preferably at most 0.1%, particularly preferably at most 0.05%, as represented by mass percentage.

In the first glass of the present invention, the above-mentioned R is at least 0.66, but when at least one component selected from B₂O₃, SrO, BaO, ZnO, Li₂O and SnO₂ is contained, the total content of such components is preferably at most 5 mol %, more preferably at most 4%, further preferably at most 3%, particularly preferably at most 2%, typically less than 1.5%.

In the second glass of the present invention, the above-mentioned R′ is at least 0.66, but when at least one component selected from ZnO, Li₂O and SnO₂ is contained, the total content of such components is preferably at most 5 mol %, more preferably at most 4%, further preferably at most 3%, particularly preferably at most 2%, typically less than 1.5%.

In the third glass of the present invention, the above-mentioned R″ is at least 0.66, but the total content of SiO₂, Al₂O₃, MgO, CaO, ZrO₂, Na₂O, K₂O, B₂O₃, SrO, BaO, ZnO, Li₂O and SnO₂ is preferably more than 95 mol %, more preferably more than 96%, further preferably more than 97%, particularly preferably more than 98%, typically more than 98.5%.

In the present invention, the method of repeating ion exchange treatment of glass is not particularly limited and may, for example, be carried out as follows. That is, 100 glass plates containing Na and having a size of from 150 to 600 cm² are put in a basket provided with slits, so that each glass plate is placed between adjacent slits so that glass plates are not in contact with one another. In a tank having a capacity of 100,000 cm³ filled with a molten potassium salt of 400° C., the basket is immersed for 8 hours to carry out ion exchange treatment, and then, the basket is taken out. Then, a basket having other glass plates put therein is immersed in the above tank, and ion exchange treatment is repeated.

### EXAMPLES

Glasses 1 and 2 in Table 1 and glass A21 in Table 3 are Examples of the glass of the present invention, and they were prepared as follows. That is, raw materials for the respective components were blended to have compositions as represented by mole percentage in columns for SiO₂ to K₂O in the Tables and melted at a temperature of from 1,550 to 1,650° C. for from 3 to 5 hours by means of a platinum crucible. During the melting, a platinum stirrer was inserted in molten glass, and the glass was stirred for 2 hours and homogenized. Then, the molten glass was cast and formed into a plate and annealed to room temperature at a cooling rate of 1° C./min.

Further, glasses in Examples 3 to 29 and 36 to 46 having compositions as represented by mole percentage in columns for SiO₂ to K₂O in Tables 4 to 8, and glasses in Examples 49 to 82, 84 and 85 having compositions as represented by mole percentage in columns for SiO₂ to SnO₂ in Tables 9 to 12, were prepared in the same manner as the preparation of the above glasses 1, 2 and A21.

With respect to these glasses, Tg (unit: ° C.), the Young's modulus E (unit: MPa), R, R′, R″, CS1 (unit: MPa), CS2 (unit: MPa) and r are shown in the Tables. Further, Tg in Examples 13 to 17, 36 to 38, 41 to 46, 61, 63, 75, 77 to 82 and 84, and E in Examples 13 to 18, 20, 23 to 25, 28, 36 to 40, 43 to 46 and 79 to 82, were obtained by calculation or assumption from the compositions, and with respect to Examples 50, 56, 65, 67, 70 to 72, 75 and 76, CS1, CS2 and r could not be accurately measured and thus were obtained by calculation or assumption from the compositions. The glasses in Examples 41 and 42 are not the glass of the present invention, and MgO is less than 3%, the Young's modulus is also low, and the fracture strength is likely to be small.

With respect to the glasses in Examples 30 to 35 in Tables 6 and 7, in Examples 47 and 48 in Table 8 and in Example 83 in Table 12, melting as described above was not carried out, and Tg, E, CS1, CS2 and r shown in these Tables were obtained by calculation of assumption from the compositions.

Examples 3 to 30, 32 to 35, 41, 42, 47, 49 to 80, 84 and 85 are Examples of the present invention. Further, Examples 41, 42 and 56 to 78 are Reference Examples of the first invention, and Examples 16, 35, 42, 79 and 80 are Reference Examples of the fourth invention.

Examples 31, 37 to 40, 43 to 46, 48, 82 and 83 are Comparative Examples of the present invention, and Examples 36 and 81 are Reference Examples.

TABLE 4

| Ex. | 3 | 4 | 5 | 6 | 7 | 8 | 9 | 10 | 11 | 12 |
|---|---|---|---|---|---|---|---|---|---|---|
| SiO₂ | 75.5 | 73.0 | 73.0 | 73.0 | 73.0 | 73.2 | 72.0 | 72.0 | 72.0 | 72.0 |
| Al₂O₃ | 4.9 | 5.0 | 5.0 | 7.0 | 7.0 | 7.0 | 7.0 | 7.0 | 6.0 | 6.0 |
| MgO | 5.9 | 8.0 | 10.0 | 5.5 | 5.5 | 5.5 | 10.0 | 9.0 | 12.0 | 14.0 |
| CaO | 0 | 0 | 0 | 0 | 0 | 0 | 0 | 0 | 0 | 0 |
| ZrO₂ | 0 | 0 | 0 | 0.5 | 0.5 | 0.3 | 0 | 0 | 0 | 0 |
| Na₂O | 13.7 | 14.0 | 12.0 | 14.0 | 14.0 | 14.0 | 11.0 | 12.0 | 10.0 | 8.0 |
| K₂O | 0 | 0 | 0 | 0 | 0 | 0 | 0 | 0 | 0 | 0 |
| Tg | 586 | 600 | 632 | 625 | 617 | 620 | 674 | 660 | 678 | 701 |
| E | 69.7 | 70.6 | 72.9 | 73.0 | 72.3 | 74.6 | 72.8 | 72.3 | 74.3 | 73.3 |
| R | 0.78 | 0.75 | 0.73 | 0.76 | 0.76 | 0.77 | 0.71 | 0.73 | 0.69 | 0.67 |
| R′ | 0.78 | 0.75 | 0.73 | 0.76 | 0.76 | 0.77 | 0.71 | 0.73 | 0.69 | 0.67 |
| R″ | 0.78 | 0.75 | 0.73 | 0.76 | 0.76 | 0.77 | 0.71 | 0.73 | 0.69 | 0.67 |
| CS1 | 684 | 810 | 895 | 915 | 870 | 889 | 940 | 963 | 862 | 681 |
| CS2 | 575 | 651 | 637 | 719 | 696 | 699 | 667 | 711 | 595 | 502 |
| r | 0.84 | 0.80 | 0.71 | 0.79 | 0.80 | 0.79 | 0.71 | 0.74 | 0.69 | 0.74 |

TABLE 5

| Ex. | 13 | 14 | 15 | 16 | 17 | 18 | 19 | 20 | 21 | 22 |
|---|---|---|---|---|---|---|---|---|---|---|
| SiO₂ | 71.7 | 71.4 | 70.0 | 70.1 | 71.1 | 73.6 | 72.4 | 74.0 | 72.0 | 73.6 |
| Al₂O₃ | 7.1 | 8.2 | 9.0 | 6.0 | 9.3 | 6.5 | 7.5 | 7.0 | 7.0 | 7.0 |
| MgO | 8.1 | 6.1 | 7.0 | 10.3 | 4.1 | 6.0 | 6.0 | 5.0 | 7.0 | 6.0 |
| CaO | 0 | 0 | 0 | 0 | 0 | 0 | 0 | 0 | 0 | 0 |
| ZrO₂ | 0 | 0 | 0 | 0.63 | 0 | 0 | 0 | 0 | 0 | 0 |
| Na₂O | 13.1 | 14.3 | 14.0 | 12.0 | 15.5 | 13.9 | 14.1 | 14.0 | 14.0 | 13.4 |
| K₂O | 0 | 0 | 0 | 1.0 | 0 | 0 | 0 | 0 | 0 | 0 |
| Tg | 603* | 603* | 609* | 596* | 603* | 613 | 628 | 613 | 623 | 626 |
| E | 74* | 72* | 73* | 75* | 71* | 72* | 69.3 | 71* | 69.7 | 69.3 |
| R | 0.74 | 0.75 | 0.74 | 0.68 | 0.77 | 0.77 | 0.76 | 0.78 | 0.75 | 0.76 |
| R′ | 0.74 | 0.75 | 0.74 | 0.68 | 0.77 | 0.77 | 0.76 | 0.78 | 0.75 | 0.76 |
| R″ | 0.74 | 0.75 | 0.74 | 0.68 | 0.77 | 0.77 | 0.76 | 0.78 | 0.75 | 0.76 |
| CS1 | 963 | 972 | 1065 | 952 | 936 | 816 | 926 | 811 | 917 | 881 |
| CS2 | 725 | 753 | 790 | 667 | 748 | 667 | 711 | 662 | 689 | 718 |
| r | 0.75 | 0.77 | 0.74 | 0.70 | 0.80 | 0.82 | 0.77 | 0.82 | 0.75 | 0.81 |

TABLE 6

| Ex. | 23 | 24 | 25 | 26 | 27 | 28 | 29 | 30 | 31 | 32 |
|---|---|---|---|---|---|---|---|---|---|---|
| SiO₂ | 72.4 | 73.7 | 72.3 | 73.0 | 72.6 | 73.4 | 72.5 | 77.0 | 60.0 | 77.0 |
| Al₂O₃ | 7.0 | 8.1 | 5.9 | 8.0 | 7.0 | 7.0 | 6.2 | 3.0 | 12.0 | 3.0 |
| MgO | 6.0 | 4.0 | 7.9 | 6.0 | 7.0 | 5.0 | 8.5 | 3.0 | 10.0 | 12.0 |
| CaO | 0 | 0 | 0 | 0 | 0 | 0 | 0 | 0 | 0 | 0 |
| ZrO₂ | 0 | 0 | 0 | 0 | 0 | 0 | 0 | 0 | 0 | 0 |
| Na₂O | 14.6 | 14.1 | 13.9 | 13.0 | 13.4 | 14.6 | 12.8 | 17.0 | 18.0 | 8.0 |
| K₂O | 0 | 0 | 0 | 0 | 0 | 0 | 0 | 0 | 0 | 0 |
| Tg | 603 | 625 | 612 | 654 | 631 | 604 | 627 | 552 | 592 | 613 |
| E | 72* | 70* | 73* | 70.0 | 69.9 | 71* | 70.2 | 68 | 76 | 76 |
| R | 0.76 | 0.78 | 0.75 | 0.76 | 0.75 | 0.78 | 0.74 | 0.84 | 0.67 | 0.72 |
| R′ | 0.76 | 0.78 | 0.75 | 0.76 | 0.75 | 0.78 | 0.74 | 0.84 | 0.67 | 0.72 |
| R″ | 0.76 | 0.78 | 0.75 | 0.76 | 0.75 | 0.78 | 0.74 | 0.84 | 0.67 | 0.72 |
| CS1 | 835 | 855 | 883 | 941 | 925 | 807 | 915 | 1100 | 1400 | 1000 |
| CS2 | 681 | 683 | 678 | 725 | 696 | 656 | 688 | 957 | 896 | 730 |
| r | 0.82 | 0.80 | 0.77 | 0.77 | 0.75 | 0.81 | 0.75 | 0.87 | 0.64 | 0.73 |

TABLE 7

| Ex. | 33 | 34 | 35 | 36 | 37 | 38 | 39 | 40 |
|---|---|---|---|---|---|---|---|---|
| SiO₂ | 77.0 | 77.0 | 77.0 | 68.3 | 66.4 | 66.0 | 64.0 | 65.5 |
| Al₂O₃ | 3.0 | 3.0 | 3.0 | 6.0 | 6.0 | 7.0 | 5.4 | 5.0 |
| MgO | 3.0 | 3.0 | 3.0 | 10.5 | 10.8 | 11.0 | 5.4 | 12.0 |
| CaO | 3.0 | 0 | 0 | 0 | 0 | 0 | 4.0 | 0 |
| SrO | 0 | 0 | 0 | 0 | 0 | 0 | 0 | 0 |
| BaO | 0 | 0 | 0 | 0 | 0 | 0 | 0 | 0 |
| ZrO₂ | 0 | 4.0 | 0 | 1.3 | 1.9 | 0 | 2.5 | 2.5 |
| Na₂O | 14.0 | 13.0 | 11.0 | 12.0 | 12.0 | 12.0 | 9.6 | 10.0 |
| K₂O | 0 | 0 | 6.0 | 2.0 | 3.0 | 4.0 | 9.1 | 5.0 |
| Tg | 574 | 610 | 570 | 601* | 599* | 587* | 575 | 632 |
| E | 70 | 73 | 63 | 75* | 75* | 73* | 69* | 76* |
| R | 0.74 | 0.78 | 0.66 | 0.64 | 0.60 | 0.58 | 0.36 | 0.52 |
| R′ | 0.74 | 0.78 | 0.66 | 0.64 | 0.60 | 0.58 | 0.36 | 0.52 |
| R″ | 0.74 | 0.78 | 0.66 | 0.64 | 0.60 | 0.58 | 0.36 | 0.52 |
| CS1 | 1000 | 1200 | 800 | 988 | 1002 | 876 | 686 | 847 |
| CS2 | 740 | 996 | 600 | 652 | 616 | 542 | 262 | 482 |
| r | 0.74 | 0.83 | 0.75 | 0.66 | 0.61 | 0.62 | 0.38 | 0.57 |

TABLE 8

| Ex. | 41 | 42 | 43 | 44 | 45 | 46 | 47 | 48 |
|---|---|---|---|---|---|---|---|---|
| SiO₂ | 64.2 | 64.4 | 64.3 | 64.3 | 64.3 | 64.3 | 64.3 | 60.3 |
| Al₂O₃ | 12.6 | 14.0 | 8.0 | 8.0 | 8.0 | 8.0 | 11.5 | 13.5 |
| B₂O₃ | 9.6 | 6.9 | 0 | 0 | 0 | 0 | 0 | 0 |
| MgO | 0 | 0 | 6.5 | 3.5 | 5.5 | 4.5 | 9.0 | 11.0 |
| CaO | 0 | 0.1 | 0.1 | 3.1 | 1.1 | 2.1 | 0.1 | 0.1 |
| SrO | 0 | 0 | 4.1 | 0.1 | 2.6 | 1.6 | 0.1 | 0.1 |
| BaO | 0 | 0 | 0.1 | 4.1 | 1.6 | 2.6 | 0.1 | 0.1 |
| ZrO₂ | 0 | 0 | 0.5 | 0.5 | 0.5 | 0.5 | 0 | 0 |
| Na₂O | 13.6 | 14.1 | 12.5 | 12.5 | 12.5 | 12.5 | 14.9 | 15.0 |
| K₂O | 0 | 0.5 | 4.0 | 4.0 | 4.0 | 4.0 | 0 | 0 |
| Tg | 602* | 615* | 598* | 608* | 596* | 601* | 615* | 625* |
| E | 64 | 65 | 72* | 69* | 71* | 70* | 76* | 78* |
| R | 0.52 | 0.57 | 0.50 | 0.44 | 0.48 | 0.46 | 0.68 | 0.64 |
| R′ | 0.79 | 0.76 | 0.56 | 0.55 | 0.56 | 0.55 | 0.68 | 0.64 |
| R″ | 0.79 | 0.76 | 0.56 | 0.55 | 0.56 | 0.55 | 0.68 | 0.64 |
| CS1 | 857 | 1024 | 938 | 844 | 903 | 901 | 1200 | 1400 |
| CS2 | 698 | 793 | 530 | 474 | 523 | 511 | 804 | 854 |
| r | 0.81 | 0.77 | 0.56 | 0.56 | 0.58 | 0.57 | 0.67 | 0.61 |

TABLE 9

| Ex. | 49 | 50 | 51 | 52 | 53 | 54 | 55 | 56 | 57 | 58 |
|---|---|---|---|---|---|---|---|---|---|---|
| SiO₂ | 66.6 | 66.6 | 66.6 | 72.8 | 72.8 | 72.7 | 63.6 | 64.7 | 61.7 | 66.7 |
| Al₂O₃ | 5.6 | 12.5 | 12.5 | 4.5 | 10.2 | 6.8 | 6.8 | 2.8 | 2.8 | 8.3 |
| B₂O₃ | 5.6 | 4.2 | 4.2 | 4.5 | 3.4 | 2.3 | 2.3 | 8.3 | 8.3 | 8.3 |
| MgO | 0 | 0 | 0 | 0 | 0 | 0 | 9.1 | 0 | 0 | 0 |
| ZnO | 0 | 0 | 0 | 0 | 0 | 0 | 0 | 2.0 | 5.0 | 0 |
| Li₂O | 0 | 0 | 0.1 | 0 | 0 | 0 | 0 | 0 | 0 | 0 |
| Na₂O | 22.2 | 16.7 | 16.6 | 18.2 | 13.6 | 18.2 | 18.2 | 22.2 | 22.2 | 16.7 |
| Tg | 562 | 591 | 586 | 569 | 605 | 561 | 571 | 556 | 549 | 572 |
| E | 74.4 | 70.9 | 70.0 | 74.2 | 69.6 | 70.9 | 72.2 | 75.4 | 69.0 | 70.2 |
| R | 0.69 | 0.68 | 0.67 | 0.73 | 0.72 | 0.78 | 0.66 | 0.58 | 0.49 | 0.59 |
| R′ | 0.85 | 0.79 | 0.79 | 0.86 | 0.81 | 0.84 | 0.72 | 0.81 | 0.72 | 0.82 |
| R″ | 0.85 | 0.79 | 0.79 | 0.86 | 0.81 | 0.84 | 0.72 | 0.85 | 0.82 | 0.82 |
| CS1 | 685 | 1250 | 1138 | 682 | 985 | 642 | 1058 | 950 | 1030 | 925 |
| CS2 | 628 | 1025 | 931 | 622 | 820 | 525 | 760 | 808 | 782 | 831 |
| r | 0.92 | 0.82 | 0.82 | 0.91 | 0.83 | 0.82 | 0.72 | 0.85 | 0.76 | 0.90 |

TABLE 10

| Ex. | 59 | 60 | 61 | 62 | 63 | 64 | 65 | 66 | 67 | 68 |
|---|---|---|---|---|---|---|---|---|---|---|
| SiO₂ | 66.6 | 66.6 | 64.6 | 66.7 | 64.6 | 64.6 | 72.8 | 63.7 | 63.7 | 63.6 |
| Al₂O₃ | 16.7 | 16.7 | 16.7 | 12.5 | 12.5 | 12.5 | 3.4 | 4.5 | 3.4 | 2.3 |
| B₂O₃ | 5.6 | 5.6 | 5.6 | 4.2 | 4.2 | 4.2 | 10.2 | 13.6 | 10.2 | 6.8 |
| MgO | 0 | 0 | 0 | 0 | 0 | 0 | 0 | 9.1 | 9.1 | 9.1 |
| ZnO | 0 | 0 | 0 | 0 | 2.0 | 0 | 0 | 0 | 0 | 0 |
| Li₂O | 0 | 2.0 | 0 | 2.0 | 0 | 0 | 0 | 0 | 0 | 0 |
| Na₂O | 11.1 | 9.1 | 11.1 | 14.6 | 16.7 | 16.7 | 13.6 | 9.1 | 13.6 | 18.2 |
| SnO₂ | 0 | 0 | 2.0 | 0 | 0 | 2.0 | 0 | 0 | 0 | 0 |
| Tg | 634 | 618 | 630 | 553 | 592* | 605 | 571 | 552 | 563 | 563 |
| E | 65.4 | 65.6 | 63.3 | 72.6 | 68.3 | 68.5 | 71.1 | 65.8 | 72.1 | 73.5 |
| R | 0.60 | 0.54 | 0.54 | 0.62 | 0.62 | 0.62 | 0.58 | 0.35 | 0.46 | 0.56 |
| R′ | 0.76 | 0.70 | 0.70 | 0.74 | 0.74 | 0.74 | 0.86 | 0.73 | 0.74 | 0.75 |
| R″ | 0.76 | 0.77 | 0.76 | 0.80 | 0.77 | 0.80 | 0.86 | 0.73 | 0.74 | 0.75 |
| CS1 | 915 | 932 | 897 | 1090 | 1123 | 1229 | 700 | 586 | 750 | 1016 |
| CS2 | 688 | 705 | 744 | 874 | 917 | 951 | 630 | 398 | 540 | 701 |
| r | 0.75 | 0.76 | 0.83 | 0.80 | 0.82 | 0.77 | 0.90 | 0.68 | 0.72 | 0.69 |

TABLE 11

| Ex. | 69 | 70 | 71 | 72 | 73 | 74 | 75 | 76 | 77 | 78 |
|---|---|---|---|---|---|---|---|---|---|---|
| SiO₂ | 63.6 | 63.7 | 63.7 | 63.7 | 63.7 | 66.7 | 68.3 | 68.3 | 61.6 | 61.6 |
| Al₂O₃ | 9.1 | 6.8 | 4.5 | 13.6 | 10.2 | 2.8 | 3.4 | 6.8 | 16.7 | 12.5 |
| B₂O₃ | 9.1 | 6.8 | 4.5 | 4.5 | 3.4 | 8.3 | 10.2 | 6.8 | 5.6 | 4.2 |
| MgO | 9.1 | 9.1 | 9.1 | 9.1 | 9.1 | 0 | 0 | 0 | 0 | 0 |
| ZnO | 0 | 0 | 0 | 0 | 0 | 0 | 0 | 0 | 5.0 | 5.0 |
| ZrO₂ | 0 | 0 | 0 | 0 | 0 | 0 | 4.5 | 4.5 | 0 | 0 |
| Na₂O | 9.1 | 13.6 | 18.2 | 9.1 | 13.6 | 22.2 | 13.6 | 13.6 | 11.1 | 16.7 |
| Tg | 576 | 571 | 562 | 650 | 598 | 574 | 571* | 589 | 643* | 577* |
| E | 64.8 | 72.5 | 73.9 | 72.3 | 71.1 | 78.3 | 68.5 | 68 | 76.7 | 68.1 |
| R | 0.44 | 0.53 | 0.61 | 0.54 | 0.60 | 0.63 | 0.52 | 0.59 | 0.46 | 0.53 |
| R′ | 0.70 | 0.72 | 0.74 | 0.67 | 0.69 | 0.87 | 0.80 | 0.78 | 0.61 | 0.65 |
| R″ | 0.70 | 0.72 | 0.74 | 0.67 | 0.69 | 0.87 | 0.80 | 0.78 | 0.71 | 0.74 |
| CS1 | 709 | 950 | 930 | 740 | 1102 | 837 | 940 | 1020 | 963 | 1246 |
| CS2 | 502 | 665 | 660 | 488 | 786 | 769 | 780 | 826 | 698 | 927 |
| r | 0.71 | 0.70 | 0.71 | 0.66 | 0.71 | 0.92 | 0.83 | 0.81 | 0.72 | 0.74 |

TABLE 12

| Ex. | 79 | 80 | 81 | 82 | 83 | 84 | 85 |
|---|---|---|---|---|---|---|---|
| SiO₂ | 64.0 | 63.0 | 61.0 | 65.3 | 66.7 | 68.0 | 68.0 |
| Al₂O₃ | 11.0 | 12.0 | 11.0 | 7.0 | 3.6 | 9.0 | 10.0 |
| MgO | 9.0 | 7.0 | 13.0 | 11.2 | 12.1 | 8.0 | 8.0 |
| CaO | 0 | 0 | 0 | 0 | 1.1 | 0 | 0 |
| SrO | 0 | 0 | 0 | 0 | 0.6 | 0 | 0 |
| ZrO₂ | 0 | 0 | 0.8 | 0.5 | 0.7 | 0 | 0 |
| Na₂O | 15.0 | 17.0 | 14.2 | 9.0 | 11.0 | 15.0 | 14.0 |
| K₂O | 1.0 | 1.0 | 0 | 7.0 | 4.2 | 0 | 0 |
| Tg | 607 | 600 | 618 | 600 | 574 | 632 | 663 |
| E | 74.5 | 73.0 | 79.8 | 71.3 | 74.4 | 71.1 | 72.1 |
| R | 0.66 | 0.68 | 0.63 | 0.49 | 0.53 | 0.72 | 0.71 |
| R′ | 0.66 | 0.68 | 0.63 | 0.49 | 0.53 | 0.72 | 0.71 |
| R″ | 0.66 | 0.68 | 0.63 | 0.49 | 0.53 | 0.72 | 0.71 |
| CS1 | 1178 | 1223 | 1231 | 646 | 500 | 1141 | 1189 |
| CS2 | 817 | 859 | 810 | 376 | 260 | 839 | 855 |
| r | 0.69 | 0.70 | 0.66 | 0.58 | 0.52 | 0.74 | 0.72 |

### INDUSTRIAL APPLICABILITY

The method of the present invention is useful for the production of e.g. a cover glass for display devices. Further, it is useful also for the production of e.g. a solar cell substrate or a window glass for aircrafts.

The entire disclosures of Japanese Patent Application No. 2011-114783 filed on May 23, 2011 and Japanese Patent Application No. 2011-247766 filed on Nov. 11, 2011 including specifications, claims, drawings and summaries are incorporated herein by reference in their entireties.

1. (canceled)

2. A glass for chemical tempering, which comprises, as represented by mole percentage based on the following oxides,
from 61 to 77% of SiO₂,
from 11 to 18% of Al₂O₃,
from 3 to 15% of MgO,
from 0 to 0.5% of CaO,
from 0 to 4% of ZrO₂,
from 8 to 18% of Na₂O and
from 0 to 1.9% of K₂O;
wherein a value of R calculated by the following formula by using contents of the respective components, is at least 0.66:
R=0.029×SiO₂+0.021×Al₂O₃+0.016×MgO−0.004×CaO+0.016×ZrO₂+0.029×Na₂O+0×K₂O−2.002.

3. The glass for chemical tempering according to claim 2, wherein the content of SiO₂ is at least 63%.

4. The glass for chemical tempering according to claim 2, wherein the content of Al₂O₃ is at least 11.5%.

5. The glass for chemical tempering according to claim 2, wherein the content of Al₂O₃ is at least 11.5%.

6. The glass for chemical tempering according to claim 2, wherein the content of ZrO₂ is at most 1%.

7. The glass for chemical tempering according to claim 2, which further comprises from greater than 0 to 1% of B₂O₃.

8. The glass for chemical tempering according to claim 2, wherein the total content of SiO₂ and Al₂O₃ is at most 83%.

9. The glass for chemical tempering according to claim 2, wherein the glass has a glass transition point Tg of at least 570° C.
